(19) United States
(12) Patent Application Publication
(10) Pub. No.: US 2015/0347390 A1
(43) Pub. Date: Dec. 3, 2015

(54) Compliance Standards Metadata Generation

(71) Applicant: Vavni, Inc., Santa Clara, CA (US)

(72) Inventors: Anoop Tewari, San Jose, CA (US); Jose Mejia, Palo Alto, CA (US); Severo Dsouza, Santa Clara, CA (US); Cyril Mecwan, Saratoga, CA (US); Thomas Killam, Santa Cruz, CA (US); Anthony Raj, San Jose, CA (US); Gaurav Rathod, Pune (IN)

(73) Assignee: Vavni, Inc., Santa Clara, CA (US)

(21) Appl. No.: 14/726,462

(22) Filed: May 30, 2015

Related U.S. Application Data
(60) Provisional application No. 62/006,026, filed on May 30, 2014.

(51) Int. Cl. G06F 17/27; G06F 17/28

(52) U.S. Cl. CPC G06F 17/2765; G06F 17/28

(57) ABSTRACT

Compliance standard documents can be automatically processed to generate meta data that can simplify the application of these documents to products, for example, to devise a compliance testing strategy for the products. The meta data can include the relevancy of the compliance standard documents to aspects of standard compliance, which can be established based on a characteristic of keywords found in the documents. The meta data can include clauses in the compliance standard documents that relate to aspects of standard compliance, which can be established based on a presence of the keywords in the clauses.

This patent application claims priority from U.S. provisional patent application Ser. No. 62/006,026, filed on May 30, 2014, entitled “Compliance standards Metadata Generation”.

### BACKGROUND

Many different standards, rules, laws, regulations, and guidelines may apply to products, for example, to ensure that the products are safe to used and not posing health hazard to surrounding people. Compliance standards are set, for example, by government agencies, to ensure safety of the products. Different countries can impose different sets of compliance rules, which need to be observed and complied by the companies designed and fabricated the products. Thus there is a need for companies to hire experienced people who will keep track of all compliance rules across the world, and will recommend a compliance testing strategy based on the products.

FIG. 1 illustrates a prior art process for forming a compliance strategy for a product according to some embodiments. A list of compliance standards 120, such as safety standards, radiation standards, etc., for various countries can be used to assess the compliance requirements for a product 110. A compliance strategy 130, e.g., product testing methodology, can be generated from applying the multiple standards 120 to the product 110.

This process can be very costly, time consuming, and unpredictable. For example, the FCC, IEC, EN standards for safety, EMC, radio, telephone company, environmental can include documents that, on average, contain about 200-300 pages of content. Each standard document can contain hundreds of clauses that refer to the type of compliance necessary for a specific product and a specific country. It can take weeks to analyze all the clauses in a single standard document. If there are multiple documents, it can take several months before all clauses are accounted for. The cost is generally proportionate to the time spent analyzing the clauses.

Thus there is a need for an improved systems and methods for compliance with standards around the world.

### SUMMARY OF THE EMBODIMENTS

In some embodiments, the present invention discloses methods, and systems to perform the methods, for simplifying a process of devising a compliance testing strategy for a product. The methods can include automatically processing compliance standard documents to generate meta data. The meta data can include the relevancy of the compliance standard documents to aspects of standard compliance, which can be established based on a characteristic of keywords found in the documents. The meta data can include clauses in the compliance standard documents that relate to aspects of standard compliance, which can be established based on a presence of the keywords in the clauses.

In some embodiments, the meta data can be generated based on characteristics of keywords, e.g., words or groups of words that are related to aspects of compliance. For example, if a compliance standard document has a keyword, then the compliance standard document can be related to the compliance aspects that the keyword is related to. In some embodiments, a minimum occurrence of the keyword is required to ensure of the relationship between the compliance standard document and the compliance aspects represented by the keyword.

In some embodiments, meta data can be generated for clauses in the compliance standard documents. The generated meta data can served as a compliance summary, since only the clauses that are relevant to the compliance aspects can have meta data generated. There can be no generated meta data for the clauses that are not relevant to the compliance aspects.

In some embodiments, the meta data can be generated based on the presence of keywords. For example, if a clause has a keyword, then the clause can be related to the compliance aspects that the keyword is related to. A meta data can be generated, linking the clause with the keyword or with the compliance aspects.

In some embodiments, the present invention discloses methods, and systems to perform the methods, for generating keywords for meta data generation. The methods can include counting words or groups of words in compliance standard documents. The words or groups of words with the most occurrence can be candidates for compliance keywords, e.g., words or groups of words that are related to aspects of compliance. An expert system can be used to review the candidates and to select the keywords.

### BRIEF DESCRIPTION OF THE DRAWINGS

FIG. 1 illustrates a prior art process for forming a compliance strategy for a product according to some embodiments.

FIG. 2 illustrates a process to provide a compliance strategy according to some embodiments.

FIGS. 3A-3B illustrate flow charts for generating meta data from compliance standard documents according to some embodiments.

FIG. 4 illustrates a flow chart for generating a compliance strategy from compliance meta data according to some embodiments.

FIG. 5 illustrates a configuration for compliance meta data generation according to some embodiments.

FIG. 6 illustrates a flow chart for a compliance meta data generation engine according to some embodiments.

FIGS. 7A-7B illustrate flow charts for expert system configurations according to some embodiments.

FIG. 8 illustrates a flow chart for a compliance meta data generation engine according to some embodiments.

FIG. 9 illustrates a process for a meta data generation engine according to some embodiments.

FIG. 10 illustrates a computing environment according to some embodiments.

FIG. 11 is a schematic block diagram of a sample computing environment 1100 with which the present invention can interact.

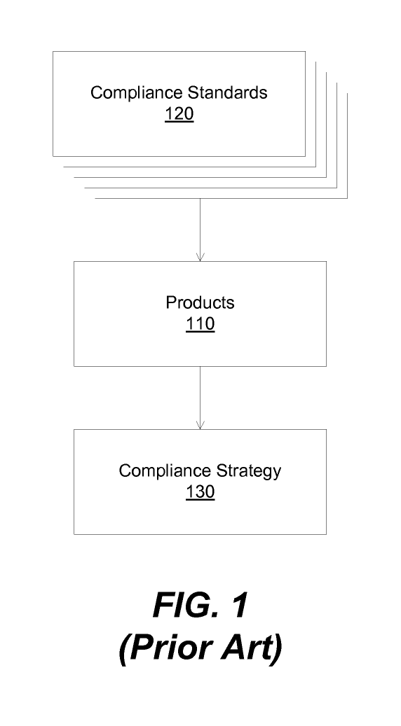

### DETAILED DESCRIPTION OF THE EMBODIMENTS

The present invention relates to the field of product regulatory compliance, including systems and methods for automating compliance procedures, such as compiling standards related to the products, which can be used to formulate a standards testing strategy.

In some embodiments, the present invention discloses systems and methods to formulate a compliant testing strategy for a product to meet the compliance standards in various fields of operation, such as to satisfy the compliance standards in certain countries or in certain aspects such as safety standards, environmental standards, or electromagnetic emission standards.

There can be many compliance standard documents, and not all of them are applicable to a particular product. Thus the compliance standard documents will have to be carefully assessed to obtain the information related to the compliance requirements of the product needed the compliance certification. In addition, the compliance standard documents can be updated or revised, and the process has to be repeated. Sometimes the compliance standard documents are interlinked, and thus an update in one compliance standard document can result in a complete revision, e.g., re-formulate the testing not only based on the updated document but also on all other affected documents.

In some embodiments, the present invention discloses systems and methods to automate or semi-automate the standards compliance process, for example, to generate a compliance testing strategy quickly and completely. The methods can include generating meta data for the compliance standard documents. The meta data can be in a format that can allow machine processed. For example, after obtaining characteristics of a product, the meta data can identify the compliance standard documents that will need to be consulted.

In some embodiments, a meta data having a first field of the name of a compliance standard document and a second field of European Union can be generated for all compliance standard documents in Switzerland. Other configurations can be used, such as a first field identifying European Union and a second field identifying the name of the compliance standard document. Thus if a product is desired to obtain standard compliance in Switzerland, the meta data can quickly and completely identifying the compliance standard documents that are relevant, e.g., the compliance standard documents of Switzerland.

Similarly a meta data having a first field of the name of a compliance standard document and a second field of emission standards can be generated for all compliance standard documents that specify an acceptable level of radiation emission. Thus if a product is characterized as a radiation emitting product, such as a wifi router, the meta data can quickly and completely identifying the compliance standard documents that are relevant, e.g., the compliance standard documents governing the emission of radiation.

The meta data can be used in conjunction, e.g., allowing to narrow the number of standard documents to a complete minimum. For example, if a radiation emitting product is desired to obtain standard compliance in Switzerland, the meta data can quickly and completely identifying the emission standard documents of Switzerland, which can provide the minimum radiation permitted in Switzerland, and which can be used as guides in generating a compliance testing strategy for the product.

In some embodiments, the meta data can identify the relevant information in the compliance standard documents that are related to the compliance issue. In a typical compliance standard document, the information related to the compliance requirements can be spread out throughout the documents. For example, information related to emission standards can be mentioned in clauses 5, 26, and 80. Information related to Switzerland can be mentioned in clause 60. Meta data can be generated to capture the relevant information in compliance standard documents, without the need to read through the whole compliance standard documents. Thus, after obtaining the name of the compliance standard documents that can be relevant to a product desiring standard compliance, the meta data can identify the relevant information in the compliance standard documents that will need to be consulted when formulating the testing strategy.

In some embodiments, a meta data having a first field identifying the name of a compliance standard document, a second field identifying the clause in the compliance standard document, and a third field identifying the aspects of the compliance that the clause is referred to. For example, a meta data can have a first field of IEC-6238, which is a standard document provided by the International Electrotechnical Commission (IEC). The meta data can have a second field of C1, which identifies the first clause in the document IEC-6238. The meta data can have a third field of a list of words, such as keywords that have been identified as related to aspects of compliance. For example, the third field can have a keyword list including Information Technology, Energy Source, Electrical. The keyword list can include words in the clause C1.

Thus, the meta data can provide a compliance summary of the compliance standard documents, identifying the clauses that containing the relevant compliance information and the aspects of compliance.

Other configurations can be used, such as a sentence, a paragraph, or a portion of the documents can be used as the clause. The aspects of compliance can include the words in the clauses, or can be different words, which relate the words in the clauses with elements of compliance. For example, a word “electromagnetic field” can be translated to “emission standards”.

In some embodiments, the meta data can allow a quick summary of the compliance standard documents needed when considering a compliance strategy for a product, for example, to ensure that the products meet all the standards requirements. Further, the meta data can also allow a quick response to the product compliance testing strategy when the standards change.

In some embodiments, the present invention discloses systems and methods to automate a standard compliance process, for example, when forming a testing strategy that can satisfy the compliance requirements. The methods can include generate meta data from compliance standard documents, which can serve as a machine processable summary of the compliance standard documents.

In some embodiments, the present invention discloses systems and methods to generate machine processable documents from the regulatory compliance standards, thus can allow automatic generation of compliance requirements, which can be used in devising testing strategy for the products to satisfy the compliance standards requirements.

For example, the regulatory compliance standards, which are typically provided in a text format, can be converted or processed to generate compliance meta data, which provide a summary of the compliance standards with respect to the product requirements. The compliance meta data then can be used by a data processing system to identify the specific compliance requirements for a product, allowing generating a testing strategy for the product to satisfy the compliance requirements.

In some embodiments, the present invention discloses a compliant rule builder, which read the compliance standards of different countries and then create metadata of these compliance standards. The meta data can be used by a user to build a compliance testing strategy.

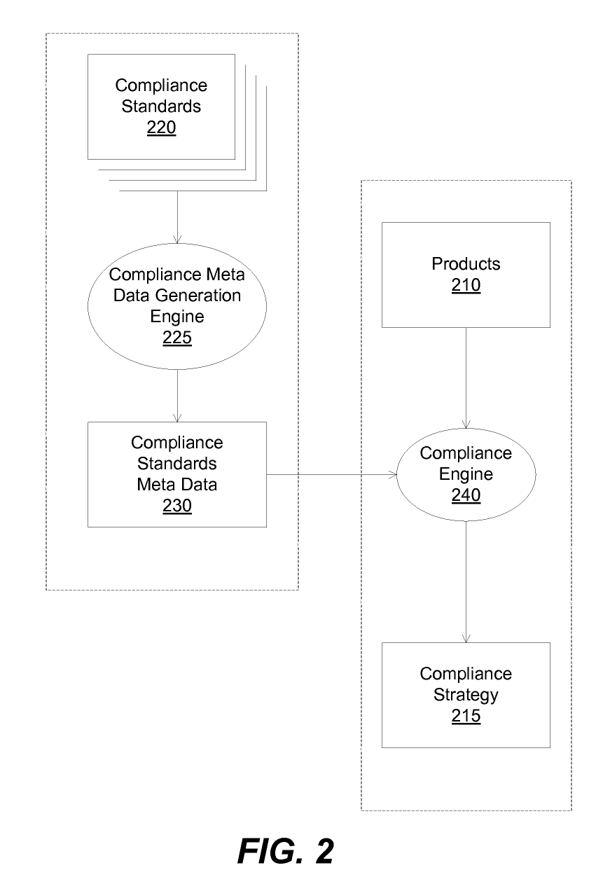

FIG. 2 illustrates a process to provide a compliance strategy according to some embodiments. Compliance standard documents 220 for different products and countries can be processed by a compliance meta data generation engine 225 to generate compliance standard meta data. The number of compliance standard documents 220 can be classified based on formulated compliance strategy. For example, if a company is only interested in standards compliance in Europe, only standard documents in Europe are processed to generate meta data related only to European countries. Similarly, if a company is only interested in certain products or certain aspects of compliance, only compliance standard documents related to the products or the specified compliance aspects are processed to generate meta data related only to the specified products.

In some embodiments, all standard documents, e.g., the documents that can be obtained, can be used to generate meta data. A meta data for the documents can include information indicating the aspects that the documents are related, so the meta data can be used to assess whether or not the documents are needed for compliance evaluation.

The compliance meta data generation engine can accept the compliance standard documents as input, and generate compliance standards meta data that contain relevant information in the compliance standard documents, such as compliance requirements related to certain countries, to certain products, or to certain aspects of compliance requirements.

In some embodiments, the compliance meta data generation engine includes logical commands, e.g., software program, to be run on a data processing system such as a computer. The compliance standard documents can be in a form that can be processed by a data processing system, such as a soft copy of a text document. For example, optical character recognition program can be performed to convert paper documents to machine processable documents.

In some embodiments, the compliance meta data generation engine can process the compliance standard documents to select information related to compliance requirements in the compliance standard documents. The information is then grouped and ordered to form meta data, which are representative of the compliance standard documents. The meta data are also formulated to allow automatic processing, for example, by a compliance engine to generate a compliance strategy for a product.

In some embodiments, the meta data can be in the form of a list, a table, or a data base. For example, the meta data for a compliance standard document can include information related to the document, such as the name of the document, or a code identified the document. The meta data can include aspects of compliance that the document is related to, such as safety standards, emission standards, or environmental standards. The meta data can include locations of clauses that contain information on compliance data, together with the aspects of compliance that the clauses are related to.

In some embodiments, a product 210 can be evaluated by the compliance engine 240, using input from the meta data 230, to generate a compliance strategy 215, e.g., information related to compliance requirements and testing procedure to obtain the information for the product. The product 210 can be represented by its characteristics, e.g., characteristics that need to be evaluated to satisfy compliance standards. For example, a power supply can be characterized as an emitter of electromagnetic radiation, and thus need to be tested to ensure that the emitted radiation is below the acceptable standards specified by the compliance standard documents related to radiation emission.

In some embodiments, the present invention discloses methods to automatically process compliance standard documents. The compliance standard documents, in paper format or in softcopy format, can be processed to generate compliance meta data, which can be a summary of the compliance standard documents and which are operable to be processed by a data processing system.

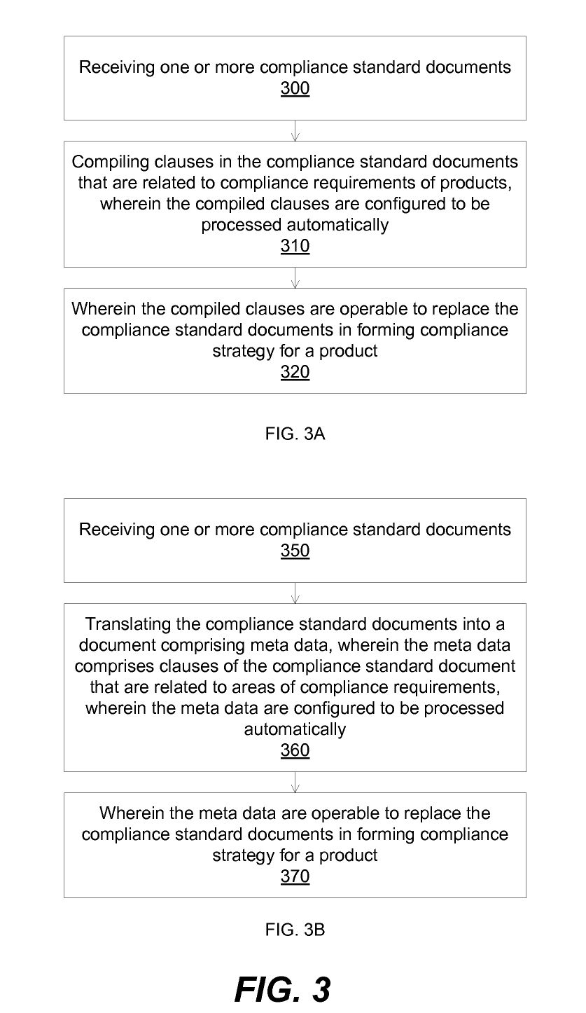

FIGS. 3A-3B illustrate flow charts for generating meta data from compliance standard documents according to some embodiments. Compliance standard documents are automatically processed to generate compliance meta data, which can be used in a data processing system to make a product comply with the compliance requirements of such a product, such as providing a testing strategy to obtain data to prove that the product complied to the compliance requirements. The automatic generation of compliance meta data can allow fast response to a change in compliance standard documents. and prevent human error

In FIG. 3A, operation 300 receives one or more compliance documents. The documents can be in a machined processable format, such as an ASCII file. If the documents are not in a machine processable format such as printed documents, addition step can be performed to convert the documents, such as performing scanning and then running an optical character recognition program to convert the scanned documents to an ASCII file. The compliance documents can be selected based on a desired to satisfy the compliance of a product.

Operation 310 compiles clauses in the compliance standard documents that are related to compliance requirements of products. For example, the compliance standard documents are examined clause-by-clause to assess the compliance aspects of the documents. Then all clauses in the compliance standard documents are evaluated one by one to obtain the clauses that relate to the compliance aspects. The related clauses are compiles to form meta data of the compliance standard documents, which are configured to be processed automatically, for example, by a data processing system. The meta data, e.g., the compiled clauses, are operable to replace the compliance standard documents in forming compliance strategy for a product (operation 320).

In FIG. 3B, operation 350 receives one or more compliance documents. Operation 360 translates the compliance standard documents into a document comprising meta data. For example, the clauses in the compliance documents are evaluated, and the clauses that are related to areas of compliance requirements are compiled to form the meta data. The meta data are configured to be processed automatically. The meta data are operable to replace the compliance standard documents in forming compliance strategy for a product (operation 370).

In some embodiments, the present invention discloses methods, and systems to perform the methods, for forming meta data, e.g., documents containing meta data or data files containing meta data. The methods can include receiving one or more compliance standard documents. Then the relevancy of the compliance standard documents to different aspects of standard compliance can be automatically established, for example, by a data processing system running an algorithm. For example, a compliance standard document X is received and processed. A meta data can be generated, linking aspects of compliance to the document. For example, the meta data can include the name or code name of the document X, and its compliance aspects, e.g., safety standards, emission standards, and European standards. Thus by having the meta data, a user could place the compliance standard document X to the appropriate place, e.g., in the compliance testing strategy for products requiring compliance in the areas of safety, emission, and European standards.

In some embodiments, the relevancy can be based on a presence of one or more keywords in the compliance standard documents. The keywords can be related to aspects of standard compliance. For example, a word “Switzerland” in a compliance standard document can show that the document can be related to European standards. Words such as “fire hazards” or “electrical hazards” in a compliance standard document can show that the document can be related to safety standards. Thus by processing the documents, e.g., looking for compliance-related keywords, a relevancy of the documents to different aspects of compliance can be established.

In some embodiments, the relevancy can be based on at least a number of the keywords in the compliance standard documents. The number of the keywords occurred in the document can exceed a threshold number before the document is considered to be related to the compliance aspect. For example, a threshold number for the keyword “safety” can be high, e.g., in the order of 100, since it can be a common word, and there can be usage of “safety” terms without relating to compliance standards. A threshold number for the keyword “Switzerland” can be low, e.g., in the order of 2, since it is not a common word in a standard document, and thus, its single presence can indicate a strong relationship to European compliance standards.

In some embodiments, the relevancy of every clause in the compliance standard documents to different aspects of standard compliance can be automatically established, for example, by a data processing system running an algorithm. The aspects standard compliance can be already established when assessing the whole document. Alternatively, there can be different aspects, e.g., additional aspects, for the clauses in the document than for the whole documents. Alternatively, the relevancy of the clauses can be established without assessing the relevancy for the whole document.

For example, a compliance standard document X is received, and each clause in the document X can be processed. A meta data can be generated, linking aspects of compliance to the clause. For example, the meta data can include the location of the clause in the document or the clause itself. The meta data can include the information in the clause that is related to the compliance aspects.

The meta data can include keywords in the clause that relate to the compliance aspects. For example, a keyword of safety hazard can relate to safety standards, a keyword of electromagnetic radiation can relate to emission standards, and a keyword of Switzerland can relate to European standards. The meta data can include the compliance aspects, e.g., safety standards, emission standards, and European standards, that the clause refers or relates to.

For clauses without any relation to the compliance aspects, there can be no meta data generated. Thus, in a way, the meta data can be considered as a summary of the document X, containing only the clauses that relate to compliance aspects. By having the meta data, a user could quickly and completely assessing the compliance standard document X, for example, by viewing the clauses mentioned in the meta data. Further, the meta data can also allow automatic processing, e.g., the met data can be used as an input in an algorithm to generate a compliance testing strategy for a product.

In some embodiments, the meta data can be used to generate compliance strategy instead of using the compliance standard documents. The compliance meta data can allow automatic processing of compliance requirements, and can allow faster process time in response to a change in compliance standards.

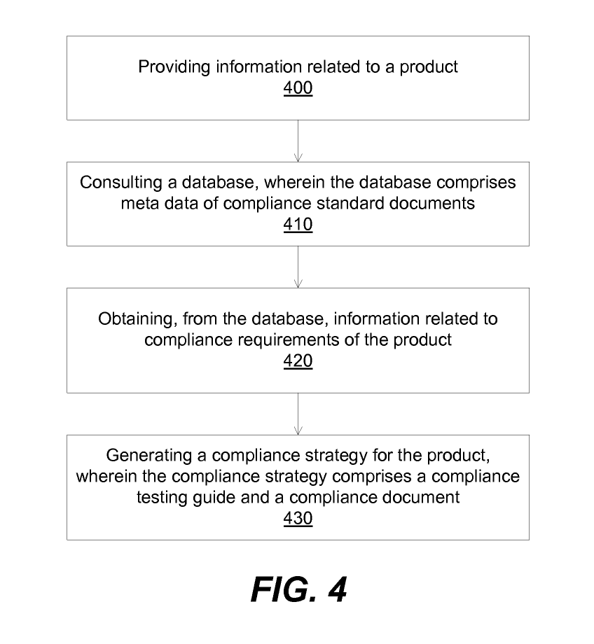

FIG. 4 illustrates a flow chart for generating a compliance strategy from compliance meta data according to some embodiments. Operation 400 provides information related to a product. The information includes characteristics of the product that are subjected to governmental regulations, such as safety or public exposure. Operation 410 consults a database, such as a document that contains compliance meta data. The database can be small or large, depending on the scope of the desired compliance strategy. For example, a large database can include compliance standards for multiple countries, covering a wide range of products. A small database can include compliance standards for a single country and for a particular set of compliance aspect.

Operation 420 obtains, from the database, information related to compliance requirements of the product. The information can be automatically gathered from the database, instead of going through the compliance standard documents. Operation 430 generates a compliance strategy for the product, wherein the compliance strategy comprises a compliance testing guide and a compliance document.

In some embodiments, the present invention discloses systems and methods to generate meta data for compliance standard documents, including using keyword in clauses to establish the relevancy of the clauses.

In some embodiments, the present invention discloses systems and methods to generate compliance meta data, which contain all information in corresponded compliance standard documents with a formulation that can allow automatic processing, e.g., to allow a data processing system, which runs a software program such as a compliance engine, to automatically generate a compliance strategy for a product. For example, the compliance meta data can be generated by a compliance meta data generation engine, using compliance standard documents as input. In some embodiments, an expert system can be included, to assist the compliance meta data generation engine, allowing the automatic generation of compliance meta data from the compliance standard documents.

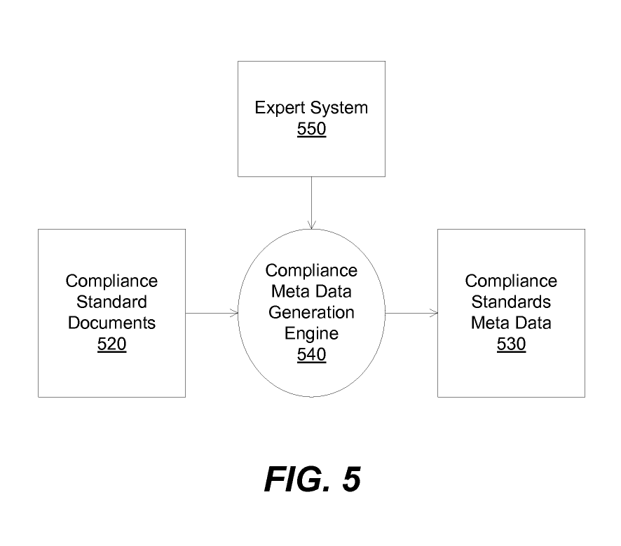

FIG. 5 illustrates a configuration for compliance meta data generation according to some embodiments. A compliance meta data generation engine 540 can accept one or more compliance standard documents 520 as input, and with assistance from an expert system 550, can generate compliance meta data 530, which can be a summary of the compliance standard documents that contains only the relevant compliance information.

In some embodiments, the expert system can include rules to allow the selection and classification of the clauses in the compliance standard documents, and assist in converting the relevant clauses to compliance meta data. For example, the expert system can contain keywords that can identify potential compliance requirements in the compliance standard documents, such as safety, electromagnetic. Further, the expert system can count the occurrence of these keywords to determine the importance of the documents with respect to the keywords.

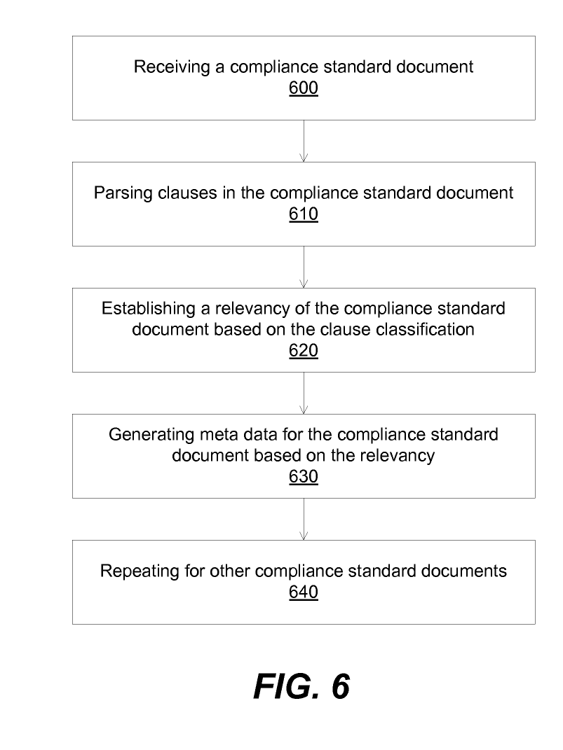

FIG. 6 illustrates a flow chart for a compliance meta data generation engine according to some embodiments. The engine classifies the clauses in received compliance standard documents based on criteria from an expert system, and then assigns a relevancy level to the classified clauses. The clauses with high relevancy can be converted to meta data, with linkage to the compliance aspect related to the relevancy.

Operation 600 receives a compliance standard document. The document can be in paper form or in softcopy, e.g., computer file represented by ASCII characters. If in paper form, the document can be pre-processed to be converted to softcopy form. The document can be a government document, issued to establish standards and guidelines to various products. The document can be a new or an updated document, meaning the compliance meta data generation engine can automatically run when there is a new or updated compliance document, to generate new compliance meta data for formulate new compliance strategy for a product.

After receiving the compliance standard document, operation 610 parses clauses in the document. For example, the engine can checking the clauses in the document to identify the clauses that relate to compliance issue, such as clauses mentioning the requirement for safety, or the requirement for maximum intensity of stray radiation or electromagnetic field. An expert system can be used to assist in the parsing of the clauses in the document. For example, the expert system can include a list of keywords that are related to compliance requirements, such as safety keyword, information technology keyword, energy source keyword, electrical keyword, power supply keyword, battery keyword, or electromagnetic keyword. The clauses that contain one or more of the keywords can be regarded as related to compliance issues of the document.

After parsing the clauses, e.g., identifying clauses that can be related to compliance requirements, operation 620 establishes a relevancy of the compliance standard document based on the clause classification. In some embodiments, the relevance of a document to a compliance issue can be based on the occurrence frequency of keywords related to the compliance issue. For example, if the keyword “safety” occurs more than about 100 times in a compliance standard document, it is likely that the document is related to safety compliance requirement of a product. The high number of occurrence signifies that the term safety can be a common word, and therefore there can be a number of clauses containing the term safety without indicating a compliance requirement. Another example is the keyword “information technology”. If this keyword occurs more than about 10 times in the document, then it is likely that the document is related to information technology compliance requirement of a product. The medium number of occurrence signifies that this keyword can be a somewhat common word, and therefore there can be a small number of clauses containing this term without indicating a compliance requirement. Another example is the keyword “Switzerland”. If this keyword occurs more than about 1 or 2 times in the document, then it is likely that the document is related to compliance requirement in Switzerland. The small number of occurrence signifies that this keyword can be a uncommon word, and therefore more than one occurrence can signify the relevancy of the document to the compliance requirements in Switzerland.

Operation 630 generates meta data for the compliance standard document based on the relevancy. For example, after the document is identified as relevant to compliance requirements, meta data are generated for the document. The meta data can include information that can allow automatic processing, e.g., using the meta data instead of the standard document in establishing compliance requirements, and in formulating a testing strategy to satisfy the compliance requirements. The meta data can include information that can allow manual processing, such as providing information in a format as to allow an operator to cross checking the accuracy of the meta data. In some embodiments, the meta data can include the document name, the clauses or the clause numbers that contain the keywords, the relevant country, the type of compliance, or the category of the compliance requirements. The meta data can allow automatic processing of the compliance standard document, e.g., by removing irrelevant information from the compliance standard document, by assembling the clauses related to compliance requirements, and/or by providing a summary of the compliance standard document in a format that can allow automatic processing.

Operation 640 repeats for other compliance standard documents.

In some embodiments, the present invention discloses systems and methods to generate meta data, including assessing each clause in a compliance standard document to assess whether or not the clause is related to an aspect of compliance. The method can include receiving a compliance standard document. The compliance standard document can have multiple clauses. The clause can be a natural portion of the document, such as a sentence, a paragraph, or multiple sentences or paragraphs of the compliance standard document. Alternatively, the document can be partitioned into multiple portions, with each portion being a clause.

Each clause can be processed, for example, to determine whether the clause is relevant to the aspects of compliance. If the clause is relevant, a meta data can be generated for the clause. If the clause is not relevant, no meta data is generated, e.g., the irrelevant clause can be skipped or removed from the standard document without affecting the compliance requirements of the document.

For each clause, keywords can be identified in the clause, e.g., whether or not the keywords are present in the clause. The keywords are configured to be related to aspects of standard compliance. The keywords can be words used in the compliance standard document that carry a meaning of compliance aspect. The keywords can include a word, one or more words, a sentence, or a paragraph. The keywords can have a meaning relating to a concept related to an aspect of standard compliance. The keywords can be stored in a keyword list, which can be used as an input to the process of the clauses in the document. For example, a keyword of “Switzerland” can indicate that the clause containing this keyword has some relation to standard compliance in Switzerland or in European Union. Thus a meta data can be generated from this clause, with information from this clause and a compliance aspect of Switzerland or European Union. This meta data can assist in forming a compliance testing of a product, by indicating that this clause can be evaluated for compliance when the product is considered to be sold in Switzerland or in European Union.

In some embodiments, the keywords can be obtained from assessing one or more compliance standard documents. For example, by assessing multiple compliance standard documents, a compliance standard master keyword list can be formed, which includes words from compliance standard documents that can be related to aspects of compliance. Further, a translation or a mapping can be formed, linking the keywords, e.g., words in a compliance standard master keyword list, to the compliance meaning.

For the clause having one or more keywords, a meta data can be generated for the clause. The meta data can include information in the clause, such as the clause itself, the location of the clause in the document, a paraphrase of the clause, or the information related to compliance aspect of the clause.

The meta data can include the keywords, or the compliance aspects, e.g., the compliance meaning of the keywords. For example, for the keyword of “Switzerland”, the meta data can include the keyword “Switzerland”, or the compliance aspect of “European Union”, meaning the word Switzerland can be related to a compliance in European Union.

The meta data can include other element, such as the name or code name of the compliance standard document.

In some embodiments, the compliance aspects can include safety standards, environmental standards, electromagnetic emission standards, and other standards. The compliance aspects can include an attribute of the standard compliance, such as safety, information technology, and European union. The compliance aspects can include an attribute type of the standard compliance, such as category, discipline, and country.

In some embodiments, the methods can further include forming a list of keywords that are related to aspects of standard compliance. The keywords can be used to identify aspects of compliance in the clauses of the standard documents. Since the keywords can be used to identify compliance aspects in standard documents, standard documents can be used to generate a list of keywords, e.g., the standard documents can be assessed to obtain words that are related to compliance aspects. For example, by knowing that a standard document is for safety standards, terms in the standard document that are used to describe the safety standards, such as fire hazards or electrical hazards, can be linked to the safety aspect of compliance. The list of the keywords can be stored in a compliance standard master keyword list, which can be used to assess the relevancy of clauses in a standard document.

In some embodiments, the present invention discloses methods to form a compliance standard master keyword list. Words in compliance standard documents can be identified and counted, for example, to form a word histogram for the standard documents. The words with the highest occurrences can be candidates for the compliance standard master keyword list. The candidates can be reviewed, for example, by compliance experts, to remove unsuitable words and to add words with lower counts but high relevancy.

In some embodiments, the present invention discloses a method to form a compliance standard master keyword list. One or more compliance standard documents can be provided. The compliance aspects of the compliance standard documents can be optionally identified. The compliance aspects can be used to attach compliance meaning to the keywords in the keyword list.

The words or groups of words in the compliance standard documents can be counted, e.g., forming a word histogram showing a relationship between words or groups of words and the number that these words or groups of words appear in the documents. The word histogram can be used to form candidates for the compliance standard master keyword list, including words or groups of words relevant to compliance aspects. The relevancy of the counted words or groups of words can be governed by a high number of occurrence of the counted words or groups of words, e.g., the counted words or groups of words with highest counts form the candidates for the compliance standard master keyword list. The compliance standard master keyword list can be generated, for example, by reviewing the candidates. For example, the relevancy of the counted words or groups of words is governed by a reviewing person. The keywords in the compliance standard master keyword list can be linked to compliance aspects.

In some embodiments, the method can further include repeating for a second compliance standard document. The method can also include generating a compliance testing strategy for a product. For example, a product can be provided, with desired compliance aspects identified. Compliance standard documents that are relevant to the desired compliance aspects can be selected, and a compliance strategy for the product can be devised based on the meta data of the compliance standard documents.

In some embodiments, the present invention discloses an expert system, which can provide guidance and assistance to a compliance meta data generation engine. The expert system can allow improvements to the generation engine, such as using feedback from the result of the engine to further enhancing the results. For example, by analyzing the generated meta data, the expert system can be modified to further improving the accuracy of the meta data generation.

The expert system can include a list of keywords and a rule table. The keywords are selected to provide an indication of compliance requirements. For example, a country name can be used as a keyword, which can indicate a compliance requirement in that country. Other keywords such as safety, radiation level, electromagnetic field, etc., can indicate a compliance requirement in that area.

The rule table can be selected to screen the keywords. For example, the rule table can set up a minimum number of occurrence for certain keywords before the document can be classified as a related to the compliance requirement in the keyword area.

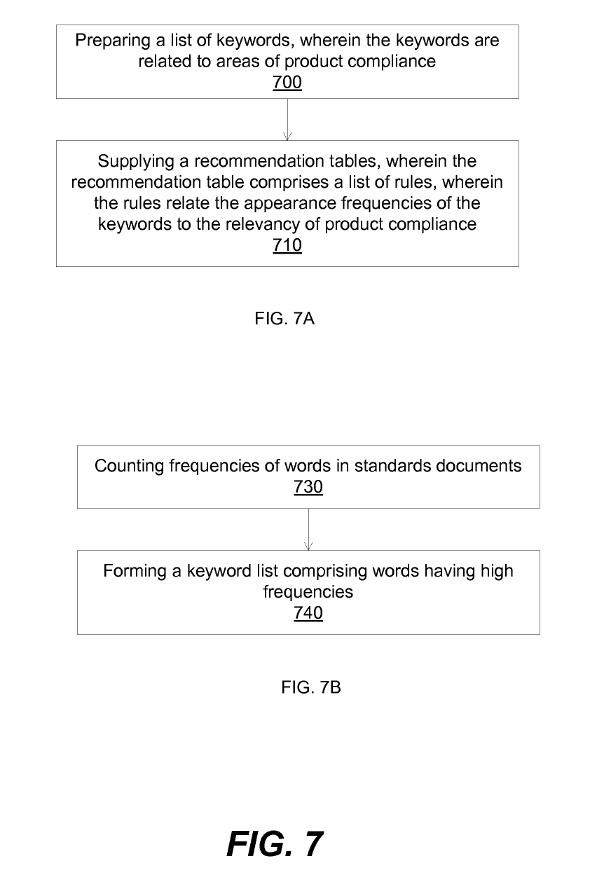

FIGS. 7A-7B illustrate flow charts for expert system configurations according to some embodiments. In FIG. 7A, operation 700 prepares a list of keywords. The keywords are related to areas of product compliance, such as country names, names of compliance issues, name of compliance requirements, etc. Operation 710 supplies a recommendation tables. The recommendation table can include a list of rules. The rules can relate the appearance frequencies of the keywords to the relevancy of product compliance.

In some embodiments, the present invention discloses methods and systems to generate a keyword list for compliance standard documents. In some embodiments, the keyword list can include words that occur frequently or have high relevancy in standard documents. For example, “Information Technology” can be a keyword to identify IEC standards because of its high rate of usage in standard documents pertaining to the International Electro technical Commission. It is one of the most relevant keywords found in a standard document. In another example, since the International Electro technical Commission standard documents covers safety standards for various energy sources, the word “Energy Source” can be found throughout the documents, which plays integral roles in the safety sections.

FIG. 7B shows a method for forming a keyword list according to some embodiments. Words in standard documents are identified and individually counted. Words having most frequent occurrences can be reviewed and classified as relevant to the standard documents, and can be used in the keyword list. An exclusion table can be added to remove words that are not relevant to compliance standards, such as proposition words.

Operation 730 counts the frequencies of words in standard documents. For example, a histogram table can be generated, with a first column includes all the words occurring in the standard documents, and a second column includes the number of times the corresponding word in the first column occurs. Operation 740 forms a keyword list, which includes words that have high frequencies of occurrence. For example, words having highest occurrences, such as top 10%, 20% or 30% highest occurrence, can be included in the keyword list.

In some embodiments, irrelevant words can be removed from being counted or from being included in the keyword list. For example, article words such as “the” or “a”, or proposition words such as “towards” are excluded. In some embodiments, verbs can be excluded. In some embodiments, adjectives and/or adverbs can be excluded.

In some embodiments, the keyword list can be reviewed by an expert, for example, by removing keywords that are not relevant or for adding keywords that are obviously relevant but having low counts in the keyword frequency table.

Table 1 shows a compliance standard master keyword table according to some embodiments.

TABLE 1
Compliance Standard Master Keyword Table
Keyword Name
Information Technology
Energy Source
Electrical
Power Supply
Battery
Electromagnetic Energy

In some embodiments, the present invention discloses methods and systems to generate a recommendation rule table for compliance standard documents. A recommendation rules table can contain rules to help classify the standard document.

In some embodiments, the recommendation table can contain a set of rules that relate keywords with keyword counts. The keywords are quantifiable then distinguished by an option and an option type. This process helps to organize keywords based on a count and give them a relationship to an attribute and attribute type.

For example, a large number of occurrence of safety term, e.g., safety being used over 100 times in a standard document, can give the document a relationship with safety as an attribute and discipline as an attribute type. In another example, Switzerland has a keyword count of 2 in the standard document. The attribute would be EU because it is part of the European Union and the attribute type would be country, because Switzerland is a country.

In some embodiments, the recommendation rules table can be created by a compliance specialist, for example, by associating the type of standards to the occurrence of keywords.

Table 2 shows a recommendation rule table using the parameters category, type and country according to some embodiments.

TABLE 2
Recommendation Rules Table

| Keyword | Operator | Count | Attribute Type | Attribute |
|---|---|---|---|---|
| Information | => | 10 | Category | IT |
| Technology | | | | |
| Safety | => | 100 | Discipline | Safety |
| Switzerland | => | 2 | Country | EU |

In some embodiments, the present invention discloses systems and methods to establish a relevancy of a compliance standard document to compliance aspects. The relevancy can be expressed in term of meta data, for example, a meta data identifying the document with the compliance aspects. In some embodiments, the relevancy can be determined using keywords and occurrence of keywords in a compliance standard document.

In some embodiments, the present invention discloses a method for generating meta data for compliance standard documents. The method can determine the compliance aspects that a compliance standard document is related to, e.g., the compliance standard document that a product will need to consult when devising a compliance testing strategy in order to meet the aspects of compliance. The meta data can allow a user to automatically identify the compliance standard documents when devising a compliance testing strategy for a product.

In some embodiments, the method can include receiving a compliance standard document. The compliance standard document can be processed, for example, to determine whether the document is relevant to the aspects of compliance. Meta data can be generated for the document for all relevant aspects of compliance.

Keywords can be identified in the document. The keywords are configured to be related to aspects of standard compliance. The keywords can be words used in the compliance standard document that carry a meaning of compliance aspect. The keywords can include a word, one or more words, a sentence, or a paragraph. The keywords can have a meaning relating to a concept related to an aspect of standard compliance. The keywords can be stored in a keyword list, which can be used as an input to the process of the clauses in the document.

In some embodiments, the keywords can be obtained from a compliance standard master keyword list, which includes words from compliance standard documents that can be related to aspects of compliance.

Based on the identified keywords, the compliance standard document can be determined to be relevant to aspects of compliance, e.g., to the compliance aspects characterized by the keywords. The relevancy can be determined by a high number of occurrence of the identified keywords. In addition, the relevancy can be reviewed by a person, such as an expert.

In some embodiments, the method can be repeated for another compliance standard document. The meta data can be used when devising a compliance testing strategy for a product.

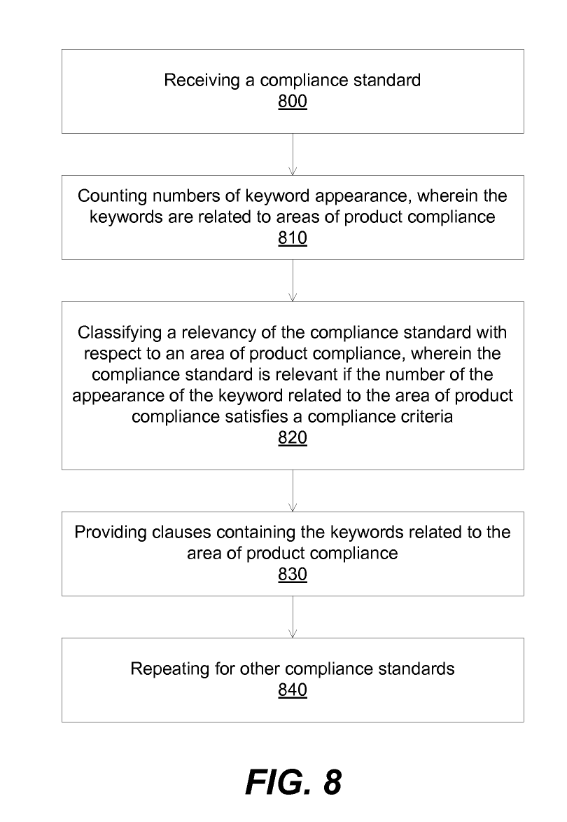

FIG. 8 illustrates a flow chart for a compliance meta data generation engine according to some embodiments. The engine matches keywords from a keyword list to the compliance standard document, and then counts the numbers of keyword matches. The numbers of keyword matches can be checked against a rule table to identify whether or not the document is classified as relevant to the compliance requirements. Meta data can be produced from the keyword matches, for relevant compliance documents.

Operation 800 receives a compliance standards. Operation 810 counts numbers of keyword appearance, wherein the keywords are related to areas of product compliance. Operation 820 classifies a relevancy of the compliance standards with respect to an area of product compliance, wherein the compliance standards is relevant if the number of the appearance of the keyword related to the area of product compliance satisfies a compliance criteria. Operation 830 provides clauses containing the keywords related to the area of product compliance. Operation 840 repeats for other compliance standards.

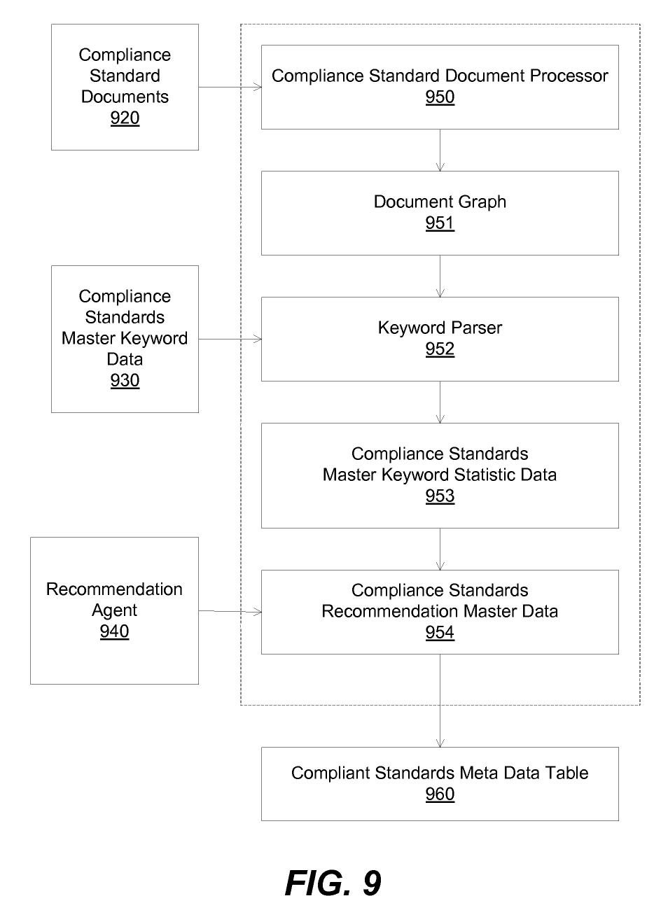

FIG. 9 illustrates a process for a meta data generation engine according to some embodiments. A standard document (IEC-6238B) provided by the International Electro technical Commission (IEC) can be used as an illustrative example.

A compliance standard document processor 950 can receive and process all the compliance standard documents 920. The compliance standard document processor can populate a document graph 951, which includes information from the compliance standard documents 920, and which can be used as input for generating meta data. Alternatively, each compliance standard document can be processed individually to generate meta data for each document.

A keyword parser 952 can read the document graph 951 and looks for keywords, which can be previously created in a compliance standards master keyword data 930 to be used as input for the keyword parser. A master keyword list can be built at a start of the analysis process, which can assist in analyze the document for the required keyword patterns. This list can be generated through the analysis of the standard document. For example, all IEC standard documents can be scanned, and a word histogram of the documents is generated. The word histogram can include a frequency occurrence of the words in the standard documents. From the word histogram, most occurrence keywords can be selected, which can signify the relevancy of various aspects of the standard documents. In addition, the keyword list can be frequently updated.

The keyword parser can identify the clauses containing the keywords in the keyword list, and can form a list of clauses and keywords. An example of keyword list is shown in Table 1. Table 3 shows a table of keyword—clause using the keyword list of Table 1.

TABLE 3
Compliance Standards Keyword - Clause Table

| Document Name | Clause No. | Keyword List |
|---|---|---|
| IEC 6238 | C1 | Information Technology, |
| | | Energy Source, Electrical |
| IEC 6238 | C2 | Energy Source, Radiation, |
| | | Injury |
| IEC 6238 | C3 | Mechanical, Fire Hazard, |
| | | Insulation |

The keyword parser can then generate a compliance standards master keyword statistics data 953, which include the numbers of occurrence of the keywords in the compliance standards master keyword data 930. Table 4 shows a table of keyword statistics according to some embodiments.

TABLE 4
Compliance Standards Keyword Statistics Table (for Keyword Count)

| Document Name | Keyword Name | Count |
|---|---|---|
| IEC 6238 | Information Technology | 10 |
| IEC 6238 | Energy Source | 20 |
| IEC 6238 | Electrical | 40 |

A compliance standards recommendation master data 954 can be created using the information from the keyword statistics data 953. The recommendation master data 954 can be assessed by a recommendation agent 940 to recommend the relevancy of the compliance standard documents to the compliance keywords, e.g., to the compliance requirements and issues.

The keyword statistic table can be evaluated using a recommendation rule table, such as a rule table shown in Table 2. After applying the rule to the standard documents, e.g., to the tables of keyword counts, a recommendation master table as shown in Table 5 can be obtained.

TABLE 5
Recommendation Master Table

| | | | | No. of |
|---|---|---|---|---|
| Document Name | Country | Type | Category | Keywords |
| IEC 6238 | EU | Safety | IT | 30 |
| IEC 600027-1 | EU | Safety | IT | 40 |
| IEC 600065 | EU | Safety | IT | 50 |

A compliance standards meta data table 960 can be generated, including the meta data formation relevant to the compliance standards. The meta data table can contain information about the country and the products that are impacted by the standards. For example, the recommendations agent will pull the keyword count from the compliance standards keyword statistics table and rules from the recommendation master table to generate the compliance standards metadata table as shown in Table 6.

TABLE 6
Compliance Standards Metadata table

| Standards | Category | Type | Country | Clause |
|---|---|---|---|---|
| IEC-6238 | IT | Safety | EU | C1 |
| IEC-6238 | IT | Safety | EU | C2 |
| IEC-6238 | IT | Safety | NA | C3 |
| IEC-6238 | IT | Safety | NA | C4 |

In some embodiments, provided is a machine readable storage, having stored there on a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, a nonvolatile electronic memory, or the like. The software program may be run on a variety of devices, e.g. a processor.

In some embodiments, the methods can be realized in hardware, software, or a combination of hardware and software. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

The terms “computer program”, “software”, “application”, variants and/or combinations thereof, in the context of the present specification, mean any expression, in any language, code or notation, of a set of instructions intended to cause a system having an information processing capability to perform a particular function either directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system, such as a general purpose computer system. A general purpose computer system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This general purpose computer may be one of the many types well known in the art, such as a mainframe computer, a minicomputer, a workstation, or a personal computer.

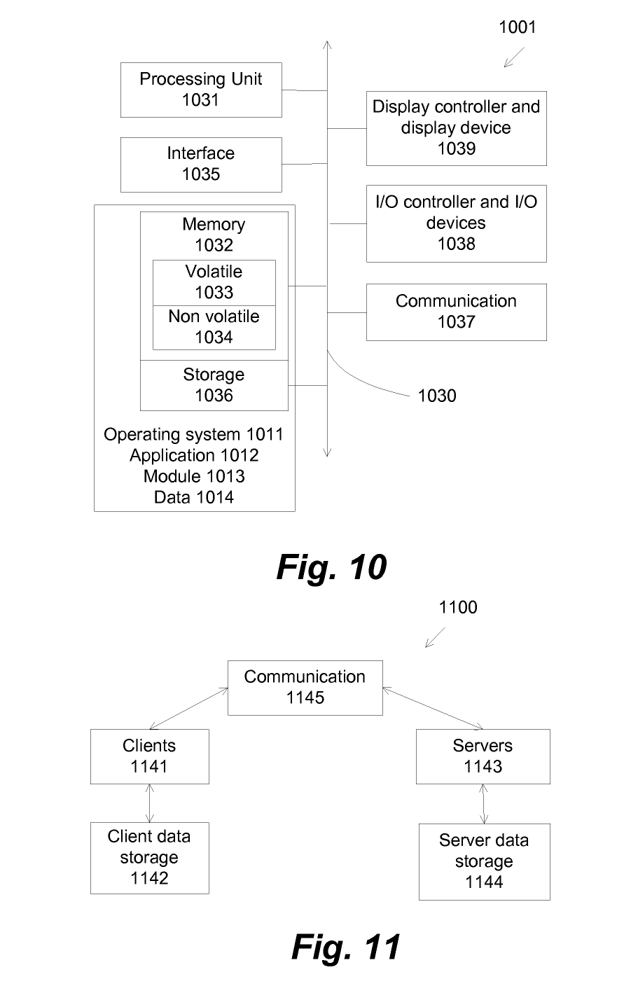

FIG. 10 illustrates a computing environment according to some embodiments. An exemplary environment for implementing various aspects of the invention includes a computer 1001, comprising a processing unit 1031, a system memory 1032, and a system bus 1030. The processing unit 1031 can be any of various available processors, such as single microprocessor, dual microprocessors or other multiprocessor architectures. The system bus 1030 can be any type of bus structures or architectures, such as 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCST).

The system memory 1032 can include volatile memory 1033 and nonvolatile memory 1034. Nonvolatile memory 1034 can include read only memory (ROM), programmable ROM (PROM), electrically programmable ROM (EPROM), electrically erasable ROM (EEPROM), or flash memory. Volatile memory 1033, can include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

Computer 1001 also includes storage media 1036, such as removable/nonremovable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1035 can be used to facilitate connection.

The computer system 1001 further can include software to operate in environment, such as an operating system 1011, system applications 1012, program modules 1013 and program data 1014, which are stored either in system memory 1032 or on disk storage 1036. Various operating systems or combinations of operating systems can be used.

Input devices can be used to enter commands or data, and can include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1038. Interface ports 1038 can include a serial port, a parallel port, a game port, a universal serial bus (USB), and a 1394 bus. The interface ports 1038 can also accommodate output devices. For example, a USB port may be used to provide input to computer 1001 and to output information from computer 1001 to an output device. Output adapter 1039, such as video or sound cards, is provided to connect to some output devices such as monitors, speakers, and printers.

Computer 1001 can operate in a networked environment with remote computers. The remote computers, having a memory storage device, can be a personal computer, a server, a router, a network PC, a workstation, a microprocessor based appliance, a peer device or other common network node and the like, and typically includes many or all of the elements described relative to computer 1001. Remote computers can be connected to computer 1001 through a network interface and communication connection 1037, with wire or wireless connections. Network interface can be communication networks such as local-area networks (LAN), wide area networks (WAN) or wireless connection networks. LAN technologies include Fiber Distributed Data Interface (FDDI), Copper Distributed Data Interface (CDDI), Ethernet/IEEE 1202.3, Token Ring/IEEE 1202.5 and the like. WAN technologies include, but are not limited to, point-to-point links, circuit switching networks like Integrated Services Digital Networks (ISDN) and variations thereon, packet switching networks, and Digital Subscriber Lines (DSL).

FIG. 11 is a schematic block diagram of a sample computing environment 1100 with which the present invention can interact. The system includes a plurality of client systems 1141. The system also includes a plurality of servers 1143. The servers 1143 can be used to employ the present invention. The system includes a communication network 1145 to facilitate communications between the clients 1141 and the servers 1143. Client data storage 1142, connected to client system 1141, can store information locally. Similarly, the server 1143 can include server data storages 1144.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method comprising
providing a compliance standard document;
identifying keywords in the compliance standard document, wherein the keywords are related to aspects of standard compliance;
determining whether the compliance standard document is relevant to the aspects of standard compliance based on a characteristic of the keywords.

2. A method as in claim 1
wherein the keywords comprises a word, one or more words, a sentence, or a paragraph.

3. A method as in claim 1
wherein the keywords comprises a concept related to an aspect of standard compliance.

4. A method as in claim 1
wherein the keywords are obtained from assessing one or more compliance standard documents.

5. A method as in claim 1
wherein the keywords are obtained from a compliance standard master keyword list.

6. A method as in claim 1 further comprising
providing one or more compliance standard documents;
identifying aspects of standard compliance of the one or more compliance standard documents;
counting words or groups of words in the one or more compliance standard documents;
generating a compliance standard master keyword list, wherein the compliance standard master keyword list comprises a list of the counted words or groups of words that are relevant to the aspects of standard compliance, wherein the words or groups of words in the compliance standard master keyword list are configured to be used as the keywords.

7. A method as in claim 1
wherein the relevancy of the counted words or groups of words is governed by a high number of occurrence of the counted words or groups of words.

8. A method as in claim 1
wherein the relevancy of the counted words or groups of words is governed by a reviewing person.

9. A method as in claim 1
wherein aspects of standard compliance comprises countries or groups of countries.

10. A method as in claim 1
wherein aspects of standard compliance comprises safety standards, environmental standards, or electromagnetic emission standards.

11. A method as in claim 1
wherein the characteristic of the keywords comprises an occurrence of the keywords greater than a number.

12. A method as in claim 1 further comprising
providing one or more compliance standard documents;
identifying aspects of standard compliance of the one or more compliance standard documents;
counting words or groups of words in the one or more compliance standard documents;
identifying the counted words or groups of words that are relevant to the aspects of standard compliance;
forming a relationship between the counted words or groups of words to the aspects of standard compliance, wherein the relationship is configured to be used as the characteristic of the keywords.

13. A method as in claim 1
wherein the relationship comprises the number of occurrence of the counted words or groups of words.

14. A method as in claim 1 further comprising
providing a product;
identifying second aspects of standard compliance for the product;
selecting compliance standard documents relevant to the second aspects of standard compliance based on a characteristic of the keywords.

15. A method comprising
providing a compliance standard document, wherein the compliance standard document comprises multiple clauses;
for each clause:
identifying one or more keywords in the clause, wherein the one or more keywords are related to one or more aspects of standard compliance;
generating a meta data for the clause based on the identification of the one or more keywords, wherein the meta data comprises a first field comprising the one or more aspects and a second field comprising information in the clause related to the one or more aspects.

16. A method as in claim 15 further comprising
providing one or more compliance standard documents;
identifying aspects of standard compliance of the one or more compliance standard documents;
counting words or groups of words in the one or more compliance standard documents;
generating a compliance standard master keyword list, wherein the compliance standard master keyword list comprises a list of the counted words or groups of words that are relevant to the aspects of standard compliance, wherein the words or groups of words in the compliance standard master keyword list are configured to be used as the keywords.

17. A method as in claim 15
wherein the one or more aspects comprises an attribute of the standard compliance.
wherein the meta data comprises a third field,
wherein the third field comprises an attribute type of the standard compliance.

18. A method as in claim 15 further comprising
providing a product;
identifying second aspects of standard compliance for the product;
selecting a compliance standard document relevant to the second aspects of standard compliance;
devising a compliance strategy for the product based on the meta data of the compliance standard document.

19. A method comprising
providing one or more compliance standard documents;
automatically establishing a relevancy of the one or more compliance standard documents with respect to aspects of standard compliance;
automatically generating a meta data for each clauses of the one or more compliance standard documents, wherein the meta data link the aspects of standard compliance with the each clause.

20. A method as in claim 19
wherein the relevancy is established based on a presence of one or more keywords in the one or more compliance standard documents, wherein the one or more keywords appear more than a threshold number in the one or more compliance standard documents, wherein the one or more keywords are related to the aspects of standard compliance.
